(19) United States
(12) Patent Application Publication
(10) Pub. No.: US 2008/0170006 A1
(43) Pub. Date: Jul. 17, 2008

(54) ORGANIC LIGHT EMITTING DISPLAY

(75) Inventors: Young-mo KOO, Suwon-si (KR); Ok-keun SONG, Suwon-si (KR); Hye-in JEONG, Suwon-si (KR); Tae-shick KIM, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/835,753

(22) Filed: Aug. 8, 2007

(30) Foreign Application Priority Data
Jan. 16, 2007 (KR) 10-2007-0004809

(51) Int. Cl. G09G 3/30

(52) U.S. Cl. 345/76

(57) ABSTRACT

An organic light emitting display capable of preventing the occurrence of a line defect. A pixel region includes a plurality of organic light emitting diodes connected to scan lines and data lines. A scan driver supplies scan signals to the scan lines. A data driver supplies data signals to the data lines. A current limit device is connected between the scan driver and the pixel region and cuts-off a flow of an electric current flowing from the scan driver to the pixel region.

### CROSS-REFERENCE TO RELATED APPLICATIONS

This application claims the benefit of Korean Patent Application No. 2007-4809, filed Jan. 16, 2007, in the Korean Intellectual Property Office, the disclosure of which is incorporated herein by reference.

### BACKGROUND OF THE INVENTION

1. Field of the Invention

Aspects of the present invention relate to an organic light emitting display, and more particular to an organic light emitting display capable of preventing the occurrence of a line defect.

2. Description of the Related Art

Recently, various flat plate displays capable of reducing the weight and volume thereof, which are disadvantages of cathode ray tubes (CRT), have been developed. An organic light emitting display device having excellent luminance and color purity using organic compounds as emitting materials has been highlighted.

FIG. 1 is a view showing a conventional organic light emitting display. Specifically, FIG. 1 shows a passive type organic light emitting display.

With reference to FIG. 1, the conventional organic light emitting display 100 includes a pixel region 110, a scan driver 120, and a data driver 130.

The pixel region 110 includes a plurality of organic light emitting diodes OLED, which are connected to scan lines S1 through Sn and data lines D1 through Dm.

Each of the organic light emitting diodes OLED functions as one pixel by emitting light corresponding to a data signal and a scan signal from a data line D and a scan line S, which are respectively coupled thereto.

The scan driver 120 sequentially supplies scan signals to first through nth scan lines S1 through Sn.

In detail, the scan driver 120 is connected to a high level voltage source and a ground voltage source, which are not shown in the drawings. Each of the scan lines S1 through Sn is switched to be connected to one of the high level voltage source and the ground voltage source according to a scan signal. Namely, a scan line S2 connected to an organic light emitting diode 112 selected to emit light is connected to the ground voltage source and remaining scan lines S are connected to the high level voltage source.

The data driver 130 supplies data signals to first through mth data lines D1 through Dm.

In the organic light emitting display 100, when a low level voltage is supplied to scan lines connected to the organic light emitting diode OLED (namely, when a scan line S coupled to the organic light emitting diode OLED is connected to the ground voltage source), the organic light emitting diode OLED is selected and emits light with a luminance corresponding to a data signal supplied from a data line D, which is coupled thereto.

For example, a ground voltage is supplied to a cathode electrode of the organic light emitting diode OLED. In addition, when a data signal having a voltage level higher than a ground voltage is supplied to an anode electrode of an organic light emitting diode 112, the organic light emitting diode 112 is biased in a forward direction. According to this, an electric current i1 corresponding to a data signal flows along a path A. Accordingly, the organic light emitting diode 112 emits light with luminance corresponding to an amplitude i1 of an electric current flowing through the organic light emitting diode 112.

At this time, the organic light emitting diodes which are not selected remain not selected as the cathode electrodes of the organic light emitting diodes are connected to the high level voltage source. As such, a reverse bias voltage is applied to the organic light emitting diodes. The application of the reverse bias voltage causes the organic light emitting diodes not to emit light.

However, when a short circuit occurs in the pixel region 110 of the organic light emitting display 100, a line defect can occur along a data line D coupled to a pixel having a short circuit defect. A detailed description thereof will be explained with reference to FIG. 2.

FIG. 2 is a view showing a short circuit defect occurring at a pixel region shown in FIG. 1. Parts of FIG. 2 corresponding to those of FIG. 1 are designated by the same symbols and the description thereof is omitted.

Referring to FIG. 2, a pixel region 110′ of the organic light emitting display 100′ includes a pixel 114 in which a short circuit occurs.

In the case that the pixel 114 in which a short circuit occurs is included in the pixel region 110′ of the organic light emitting display 100′, a line defect can occur when images are displayed along a data line D2 coupled to the pixel 114 in which a short circuit occurs.

In detail, the pixel 114 in which a short circuit defect occurs functions as a resistor instead of an organic light emitting diode OLED. Accordingly, light is not emitted during a selection period and the pixel becomes a dark point. However, the pixel becomes part of a flow path of an electric current during a non-selection period, thereby causing the line defect.

For example, when a low voltage or low level scan signal and a data signal are supplied to the second scan line S2 and the second data line D2 respectively, a first electric current i1 should flow only along a path A from the second data line D2 to the second scan line S2 through a pixel 112 coupled to the second line S2 and the second line D2.

However, when a short circuit defect occurs in a pixel 114 sharing the second data line D2 with the pixel 112 and the pixel 112 is selected by the scan signal, a second electric current i2 flows along a path B from the scan line S1 coupled to the pixel 114 having the short circuit defect to the pixel 112 selected by the scan line. Accordingly, a sum (i1+i2) of the first electric current i1 and the second electric current i2 flows through the selected pixel 112. Thus, since an over current flows through the pixel 112 selected by the scan signal, it emits light with luminance higher than predetermined luminance corresponding to a data signal. Consequently, the pixel 112 selected by the scan signal can become a bright point. In particular, when the selected pixel 112 expresses a dark gradation, the dark point clearly appears.

Furthermore, because the application of the scan signal to the second scan line S2 and, therefore, the pixel 112, stops as the scan driver progresses through the scan lines S1 through Sn, the second scan line S2 is then connected to a high level voltage source. However, in the same manner as with the pixel 112, during a supply of the scan signal to a third scan line S3, being the next scan line in the progression of the scan driver, a pixel connected to the third scan line S3 and sharing the data line D2 with the pixel 114 having a short circuit defect becomes a bright point.

Through the aforementioned manner, while the scan lines S1 through Sn are sequentially selected during one frame, a line defect occurs along a data line D2 coupled to the pixel 114 having a short circuit defect during remaining periods except for the time period in which the pixel having the short circuit defect is selected.

### SUMMARY OF THE INVENTION

Accordingly, it is an aspect of the present invention to provide an organic light emitting display that may prevent the occurrence of a line defect by cutting off a flow of an abnormal current through a pixel in which a short circuit defect occurs.

The foregoing and/or other aspects of the present invention are achieved by providing organic light emitting display comprising: a pixel region including a plurality of organic light emitting diodes connected to scan lines and data lines; a scan driver to supply scan signals to the scan lines; a data driver to supply data signals to the data lines; and a current limit device connected between the scan driver and the pixel region to cut-off a flow of an electric current flowing from the scan driver to the pixel region.

Preferably, the current limit device is disposed in at least one of the scan lines, and the current limit device is connected at each of the scan lines. More preferably, the current limit device is a diode. Most preferably, an anode electrode of the diode is connected to the pixel region, and a cathode electrode of the diode is connected to the scan driver. The current limit device may be a resistor. The current limit device may be installed inside the scan driver.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view showing a conventional organic light emitting display;

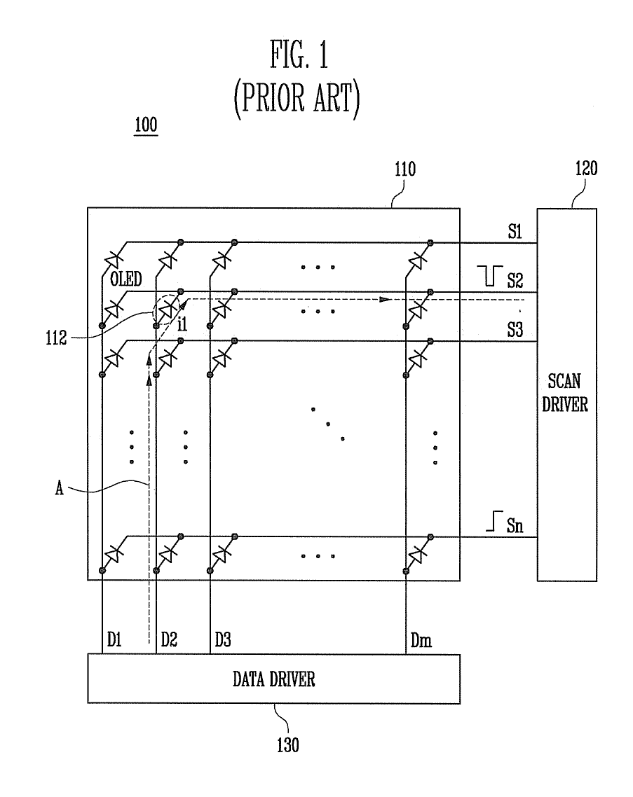

FIG. 2 is a view showing a short circuit defect occurring at a pixel region shown in FIG. 1;

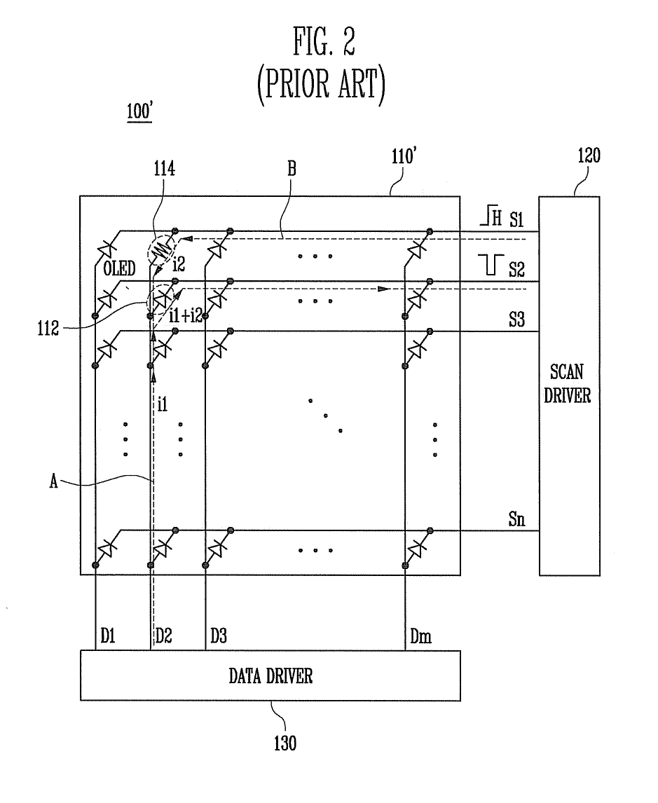

FIG. 3 is a view showing an organic light emitting display according to aspects of the present invention;

FIG. 4 is a view showing a short circuit defect occurring at a pixel region shown in FIG. 3;

FIG. 5 is a view showing an organic light emitting display according to another aspect of the present invention; and

FIG. 6 is a view showing an organic light emitting display according to a further aspect of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

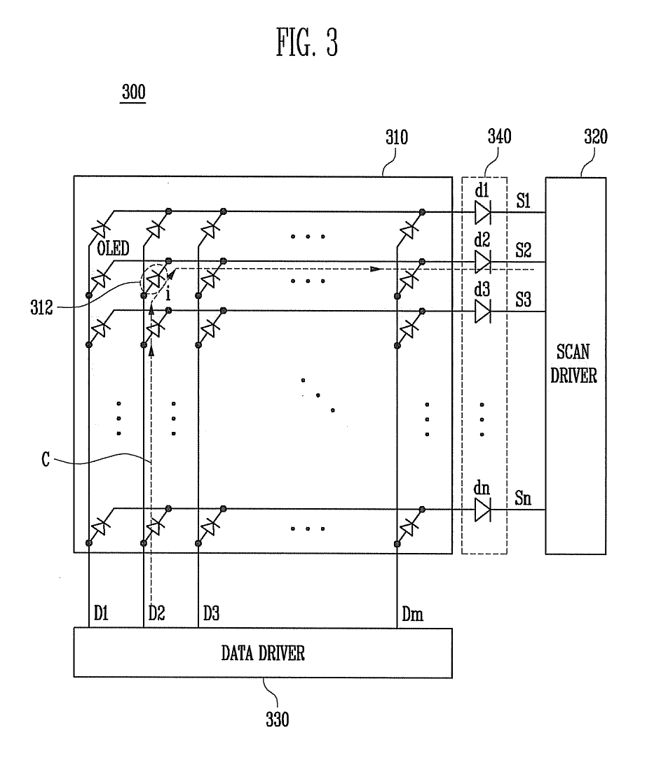

FIG. 3 is a view showing an organic light emitting display 300 according to aspects of the present invention. For convenience of the description, FIG. 3 shows a passive type organic light emitting display. However, aspects of the present invention are not limited thereto.

With reference to FIG. 3, the organic light emitting display 300 according to aspects of the present invention includes a pixel region 310, a scan driver 320, a data driver 330, and a diode group 340.

The pixel region 310 includes a plurality of organic light emitting diodes OLED, which are connected to scan lines S1 through Sn and data lines D1 through Dm.

Each organic light emitting diode OLED emits light according to a data signal and a scan signal applied thereto by a data line D and a scan line S connected thereto. Each organic light emitting diode OLED functions as one pixel. Alternatively, each organic light emitting diode OLED may function as one sub-pixel that emits one color according to the data and scan signals.

The scan driver 320 sequentially supplies scan signals to scan lines S1 through Sn. The scan driver 320 applies scan signals by progressing through the scan lines S1 through Sn from the scan line S1 sequentially to the scan line Sn.

In detail, the scan driver 320 is connected to a high level voltage source and a ground voltage source, which are not shown in drawings. Each of the scan lines S1 through Sn is switched to be connected to one of the high level voltage source and the ground voltage source according to the scan signal. Namely, a scan line S2 coupled to the organic light emitting diode 312 selected to emit light is connected to the ground voltage source, and remaining scan lines S are connected to the high level voltage source. An organic light emitting diode OLED is selected to emit light according to the data signal supplied thereto when the organic light emitting diode OLED is connected to the ground voltage source. And alternatively, an organic light emitting diode OLED selected to not emit light is connected to the high voltage source.

The data driver 330 supplies data signals to data lines D1 through Dm, starting with the data line D1 and progressing sequentially to the data line Dm.

The diode group 340 includes diodes d1 through dn comprising at least one diode d, which is connected between the scan driver 320 and the pixel region 310.

In detail, the at least one diode d included in the diode group 340 is formed in at least one of the scan lines S but the diode group 340 is not limited thereto. Each of the scan lines S1 through Sn may include diodes d1 through dn, respectively, of the diode group 340.

Here, anode electrodes of the diodes d1 through dn included in the diode group 340 are coupled to the pixel region 310. In particular, the anode electrodes of the diodes d1 through dn of the diode group 340 are connected to cathode electrodes of each organic light emitting diode OLED in the pixel region 310. Here, one organic light emitting diode OLED shares the scan line S1 with the diode d1. Further, cathode electrodes of each of the diodes d1 through dn included in the diode group 340 are coupled with the scan driver 320, more particularly, with a high level voltage source of the scan driver 320.

Accordingly, the diode group 340 functions as a unidirectional current limit device to cut-off a flow of an abnormal or unintended current from the scan driver 320 to the pixel portion 310.

In the organic light emitting display 300, when a low level voltage is supplied to a scan line connected to the organic light emitting diode OLED or, more particularly, when a scan line S coupled to the organic light emitting diode OLED is connected to a ground voltage source, the organic light emitting diode OLED is selected and emits light with a luminance corresponding to data signals supplied from data lines D, which are coupled thereto.

For example, a ground voltage is supplied to a cathode electrode of the organic light emitting diode 312. In addition, when a data signal having a voltage level higher than a ground voltage is supplied to an anode electrode of the organic light emitting diode 312, the organic light emitting diode 312 is biased in a forward direction. An electric current i corresponding to the data signal flows along a path C. Accordingly, the organic light emitting diode 312 emits light with luminance corresponding to an amplitude of the current i flowing through the organic light emitting diode 312.

At this time, as cathode electrodes of the organic light emitting diodes which are not selected, are connected to a high level voltage source, a reverse bias voltage is applied to the organic light emitting diodes. This causes the organic light emitting diodes to not emit light.

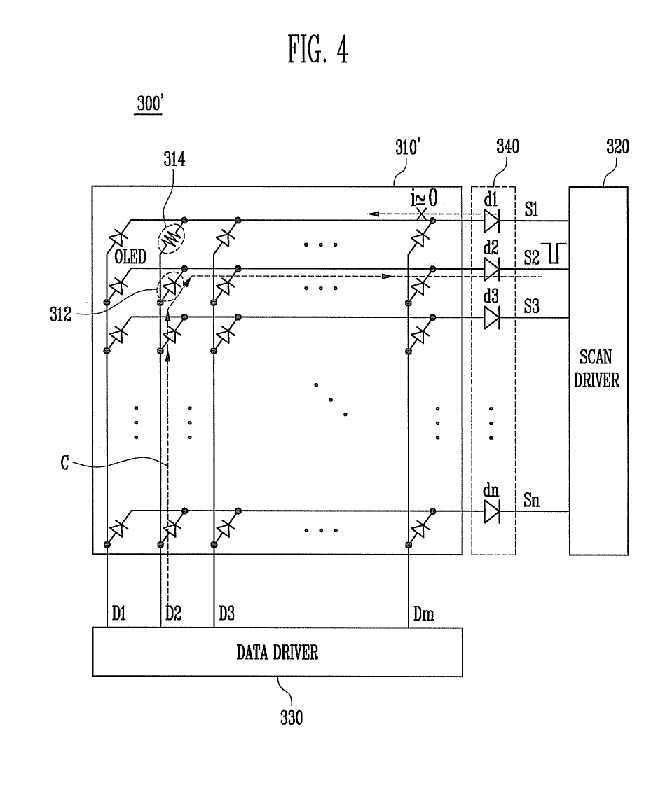

In the aforementioned organic light emitting display 300, diodes d1 through dn included in the diode group 340 allow a flow of an electric current from the pixel portion 310 to the scan driver 320 but prohibit an opposite flow thereof. Accordingly, although pixels in which a short circuit defect may occur are included in the pixel portion 310, line defects do not occur. A detailed description thereof will be described with reference to FIG. 4.

FIG. 4 is a view showing a short circuit defect occurring at a pixel 314 portion shown in FIG. 3. Parts of FIG. 4 corresponding to those of FIG. 3 are designated by the same symbols and the description thereof is omitted.

Referring to FIG. 4, a pixel region 310′ of the organic light emitting display 300′ includes a pixel 314 in which a short circuit defect occurs.

The pixel 314 itself in which a short circuit defect occurs functions as a resistor and not as an organic light emitting diode OLED. An electric current does not flow through the pixel 314 during a non-selected time period.

As such, diodes d1 through dn of the diode group 340 connected to scan lines S1 through Sn between the pixel portion 310′ and the scan driver 320, and particularly, a diode d1 connected to a scan line S1 coupled to a pixel 314 in which a short circuit defect occurs, cuts off a flow of an electric current from the scan driver 320 to the pixel 314 having a short circuit defect. Accordingly, the diode d1 cuts off an abnormal flow of an electric current through scan line S1 to the pixel 314 in which the short circuit defect occurred in the pixel portion 310′. The diodes d1 through dn limit abnormal flow of current from the scan driver 320 through the scan lines S1 through Sn to the plurality of organic light emitting diodes OLED in the pixel region 310′ if one of the organic light emitting diodes OLED is shorted so as to prevent a line defect.

In contrast to this, an electric current of a path C to a current scan line S2, or more particularly, a scan line S2 selected to supply a low level scan signal, normally flows from a data line D2 coupled to the pixel 312 selected by the scan signal through the selected pixel 312. Accordingly, a current selected pixel 312 emits light with a luminance corresponding to the data signal. Even though the pixel 314 in the pixel region 310′ is shorted, the selected pixel 312 only receives the intended data signal resulting in a normal functioning of the pixel 312 as the diode d1 prevented the abnormal current from flowing through the shorted pixel 314.

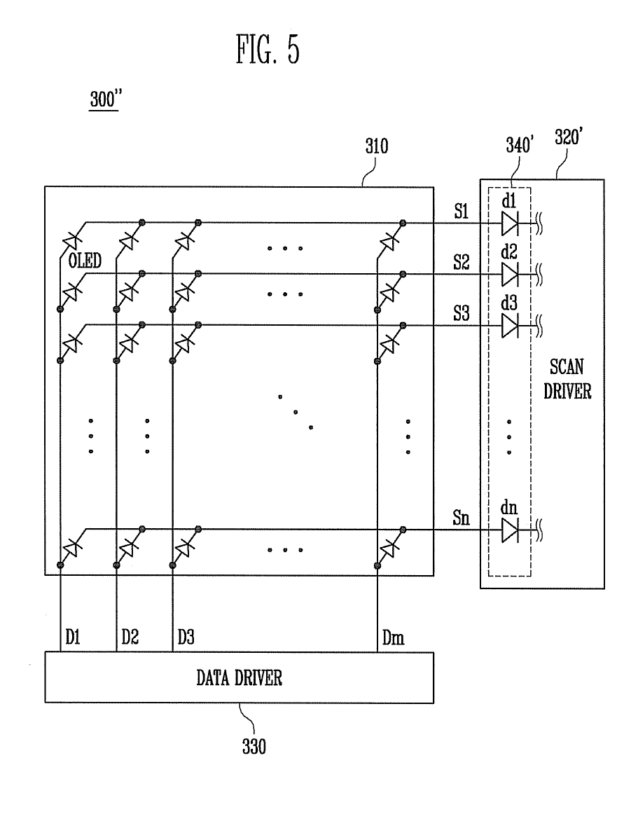

According to aspects of the current invention, as in the organic light emitting display 300″ shown in FIG. 5, the diode group 340′ can be included in the scan driver 320′. In this case, anode electrodes of the diodes d1 through dn included in the diode group 340′ are connected to the pixel region 310, and the cathode electrodes of the diodes d1 through dn are connected to a high level voltage source (not shown) in the scan driver 320′. Although a pixel having a short circuit defect may be included in the pixel region 310, the diodes d1 through dn cut off the flow of an abnormal flow of an electric current from the scan driver 320′ through the scan lines S1 through Sn to the pixel region 310 as described above.

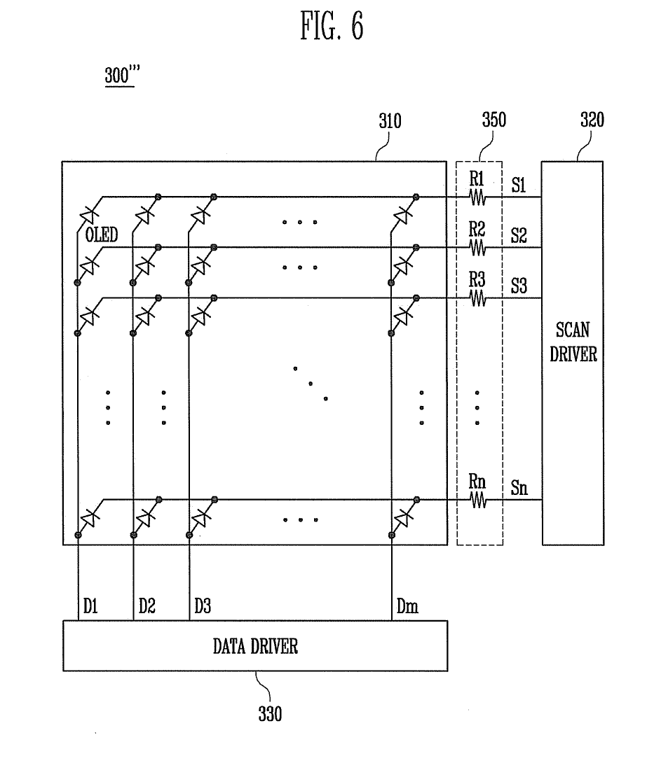

Moreover, a current limit device for cutting-off an abnormal flow of an electric current is not limited to a diode. For example, as shown in FIG. 6, the current limit device can limit an abnormal flow of the electric current with a resistor.

Referring to FIG. 6, a resistor group 350 that comprises at least one resistor R can be connected to a pixel region 310 and a scan driver 320 of an organic light emitting display 300′″.

In detail, the resistor group 350 includes resistors R1 through Rn, which are respectively formed in the scan lines S1 through Sn.

Here, the resistors R1 through Rn included in the resistor group 350 are coupled to a high level voltage source of the scan driver 320, but the resistors R1 through Rn are not coupled to a ground voltage source.

Moreover, the resistors R1 through Rn are designed to have a resistance value sufficient to cause an electric current flowing through each of the resistors R1 through Rn to be less than about 50 μA so as to substantially limit a flow of an electric current. More particularly, if the resistors R1 through Rn are designed to have a resistance value sufficient to cause an electric current flowing through each of the resistors R1 through Rn to be less than about 10 μA, for example, if the resistance value is set several MΩ, the electric current is effectively limited.

Here, since the scan lines S1 through Sn that are connected to the high level voltage source are non-selected scan lines S, an electric current flowing through the scan lines S is cut-off by the resistor R. Accordingly, when short defects occur in pixels, which are not selected by the scan signal, an abnormal flow of an electric current through the pixel with a short circuit defect is cut-off.

The scan line S selected by the scan signal is connected to a ground voltage source, but the selected scan line S is not connected to the resistors R1 through Rn included in the resistor group 350 so that an electric current from the scan driver 320 normally flows through the selected scan line S to a selected pixel. Furthermore, the resistor group 350 can be included in the scan driver 320 similar to the diode group 340.

As mentioned above, in an organic light emitting display according to aspects of the present invention, although a short circuit occurs in a pixel, a current limit device such as a diode group or a resistor group disposed between a pixel region and a scan driver cuts-off an abnormal flow of an electric current from the scan driver to the pixel region. This prevents line defects of a pixel region from occurring.

Although aspects of the present invention have been shown and described, it would be appreciated by those skilled in the art that changes may be made in this embodiment without departing from the principles and spirit of the invention, the scope of which is defined in the claims and their equivalents.

What is claimed is:

1. An organic light emitting display, comprising:
a pixel region including a plurality of organic light emitting diodes connected to scan lines and data lines;
a scan driver to supply scan signals to the scan lines;
a data driver to supply data signals to the data lines; and
a current limit device connected between the scan driver and the pixel region to substantially limit an abnormal flow of an electric current from the scan driver to the pixel region.

2. The organic light emitting display of claim 1, wherein the current limit device is disposed in at least one of the scan lines.

3. The organic light emitting display of claim 2, wherein the current limit device is disposed in each of the scan lines.

4. The organic light emitting display of claim 1, wherein the current limit device is a diode.

5. The organic light emitting display of claim 4, wherein an anode electrode of the diode is connected to the pixel region, and a cathode electrode of the diode is connected to the scan driver.

6. The organic light emitting display of claim 1, wherein the current limit device is a resistor.

7. The organic light emitting display of claim 1, wherein the current limit device is installed inside the scan driver.

8. The organic light emitting display of claim 1, wherein the resistor has a resistance sufficient to decrease the flow of current to less than about 50 μA.

9. The organic light emitting display of claim 1, wherein the current limit device comprises:
a plurality of diodes,
wherein one diode of the plurality of diodes is disposed in each respective scan line.

10. The organic light emitting display of claim 1, wherein the current limit device comprises:
a plurality of resistors,
wherein one resistor of the plurality of resistors is disposed in each respective scan lines.

11. An organic light emitting display, comprising:
display diodes disposed in a pixel region;
a scan driver;
scan lines to connect the scan driver to the diodes; and
a current limit device, wherein the current limit device is disposed between the scan driver and the display diodes to substantially limit an abnormal flow of current from the scan driver to the display diodes.

12. The organic light emitting display of claim 11, wherein the scan driver further comprises:
a high voltage source; and
a ground voltage source.

13. The organic light emitting display of claim 11, wherein the current limit device comprises at least one current limiting diode.

14. The organic light emitting display of claim 11, wherein the current limit device comprises current limiting diodes respectively disposed in each of the scan lines.

15. The organic light emitting display of claim 11, wherein the current limit device comprises at least one resistor.

16. The organic light emitting display of claim 11, wherein the current limit device comprises resistors respectively disposed in each of the scan lines.

17. The organic light emitting display of claim 12, wherein the current limit device comprises resistors disposed between the high voltage source and the display diodes.

18. A scan driver for an organic light emitting device, comprising:
a current limit device to connect to scan lines of the organic light emitting device to limit an unintended current.

19. The scan driver of claim 18, wherein the current limit device comprises:
a plurality of resistors,
wherein each resistor of the plurality of resistors is disposed to connect to one of the scan lines, respectively.

20. The scan driver of claim 18, wherein the current limit device comprises:
a plurality of diodes,
wherein each diode of the plurality of diodes is disposed to connect to one of the scan lines, respectively.
